(19) United States
(12) Patent Application Publication
(10) Pub. No.: US 2020/0311699 A1
(43) Pub. Date: Oct. 1, 2020

(54) REWARD SYSTEMS AND METHODS THAT EMPLOY BLOCKCHAIN AND DIGITAL CRYPTO TOKENS TO REWARD USERS WITHIN AN ORGANIZATION

(71) Applicant: salesforce.com, inc., San Francisco, CA (US)

(72) Inventors: Divya Ranjit, Dublin, CA (US); Medha Prabhala, Pleasanton, CA (US); Sreedhar Karukonda, Fremont, CA (US); Chad Holdorf, San Rafael, CA (US)

(21) Appl. No.: 16/364,001

(22) Filed: Mar. 25, 2019

(51) Int. Cl. G06Q 20/06; G06Q 20/38; H04L 29/08; H04L 12/24; H04L 12/26

(52) U.S. Cl. CPC G06Q 20/0658; G06Q 20/38215; G06Q 20/389; G06Q 2220/00; H04L 41/22; H04L 43/045; H04L 67/10

(57) ABSTRACT

A system is provided that includes a distributed database system (DDS) and a cloud computing platform that includes a reward system. The DDS includes a network of blockchain nodes that collectively store a distributed ledger of a blockchain. The DDS can also store a pool of digital crypto tokens for an organization and control distribution of the digital crypto tokens to users associated with the organization via a smart contract module that validates transactions involving the digital crypto tokens using smart contracts for each transaction to directly control peer-to-peer transfer of transferrable digital crypto tokens between the users under certain conditions. The reward system includes a reward module that can issue granted digital crypto tokens to users as a reward when they perform certain tasks. Each granted digital crypto token quantifies time spent performing a certain task and serves as a currency within the organization.

### TECHNICAL FIELD

Embodiments of the subject matter described herein relate generally reward systems for rewarding users within an organization. More particularly, embodiments of the subject matter relate to reward systems for rewarding users within an organization for time spent performing tasks with digital crypto tokens that serve as a currency within the organization.

### BACKGROUND

Today many enterprises now use cloud-based computing platforms that allow services and data to be accessed over the Internet (or via other networks). Infrastructure providers of these cloud-based computing platforms offer network-based processing systems that often support multiple enterprises (or tenants) using common computer hardware and data storage. This “cloud” computing model allows applications to be provided over a platform “as a service” supplied by the infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without compromising data security. Generally speaking, multi-tenancy refers to a system where a single hardware and software platform simultaneously supports multiple organizations or tenants from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost-effective sharing of similar application feature software between multiple sets of users.

Some organizations provide systems for rewarding employees. Examples of such systems include feedback applications, badges, thanks, manager feedback emails, social media recognition such as @Twitter mentions, @Chatter mentions, etc. One issue in many organizations relates to giving employees an incentive to help other users within their organization. It would be desirable to provide a system that allows for employees to be rewarded when they help other employees, for example, by giving feedback based on technical expertise, check-ins, social media posts (e.g., chatter posts), etc. It would be desirable if such a system provided quantifiable metrics and recognition for time spent helping others with tasks, questions or other problems.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic block diagram of an example of a multi-tenant computing environment in which features of the disclosed embodiments can be implemented in accordance with the disclosed embodiments.

FIG. 2 is a block diagram of a cloud-based computing platform in accordance with the disclosed embodiments.

FIG. 3 is a flow chart that illustrates an exemplary method in accordance with the disclosed embodiments.

FIG. 4 is a screenshot that shows an example of user interface in accordance with the disclosed embodiments.

FIG. 5 is a screenshot that shows an example of another user interface in accordance with the disclosed embodiments.

FIG. 6 is a screenshot that shows an example of another user interface in accordance with the disclosed embodiments.

FIGS. 7-9 are screenshots that show an example of a reward system dashboard user interface in accordance with the disclosed embodiments.

FIG. 10 shows a block diagram of an example of an environment in which an on-demand database service can be used in accordance with some implementations.

FIG. 11 shows a block diagram of example implementations of elements of FIG. 10 and example interconnections between these elements according to some implementations.

FIG. 12A shows a system diagram illustrating example architectural components of an on-demand database service environment according to some implementations.

FIG. 12B shows a system diagram further illustrating example architectural components of an on-demand database service environment according to some implementations.

FIG. 13 illustrates a diagrammatic representation of a machine in the exemplary form of a computer system within which a set of instructions, for causing the machine to perform any one or more of the methodologies discussed herein, may be executed.

### DETAILED DESCRIPTION

Blockchain technology is a relatively new technology that was originally described in a 2008 article by Satoshi Nakamoto, called “Bitcoin: A Peer-to-Peer Electronic Cash System.” The blockchain is a data structure that stores a list of transactions and can be thought of as a distributed electronic ledger that records transactions between source identifier(s) and destination identifier(s). The transactions are bundled into blocks and every block (except for the first block) refers back to or is linked to a prior block in the chain. Computer nodes maintain the blockchain and cryptographically validate each new block and thus the transactions contained in the corresponding block. This validation process includes solving a computationally difficult problem that is also easy to verify and is sometimes called a “proof-of-work.”

The integrity (e.g., confidence that a previously recorded transaction has not been modified) of the entire blockchain is maintained because each block refers to or includes a cryptographic hash value of the prior block. As such, once a block refers to a prior block, it becomes difficult to modify or tamper with the data (e.g., the transactions) contained therein. This is because even a small modification to the data will affect the hash value of the entire block. Each additional block increases the difficulty of tampering with the contents of an earlier block. Thus, even though the contents of a blockchain may be available for all to see, they become practically immutable.

The identifiers used for blockchain transactions are created through cryptography such as, for example, public key cryptography. For example, a user may create a destination identifier based on a private key. The relationship between the private key and the destination identifier can later be used to provide “proof” that the user is associated with the output from that created transaction. In other words, the user can now create another transaction to “spend” the contents of the prior transaction. Further, as the relationship between the destination identifier and the corresponding private key is only known by the user, the user has some amount of anonymity as they can create many different destination identifiers, which are only linked through the private key. Accordingly, a user's total association with multiple transactions included in the blockchain may be hidden from other users. While the details of a transaction may be publicly available on the distributed ledger, the underlying participants to those transactions may be hidden because the identifiers are linked to private keys known only to the corresponding participants.

Business transactions require trust to execute successfully, and the emergence of distributed ledgers running smart contracts validated on a blockchain have enabled the democratization of the trust process by giving a global, single view of the world that all parties can independently verify, yet no parties can independently. Before distributed ledgers, data was created as copies of the truth and was passed from person to person. Maintaining multiple copies of any file increases the potential for information mismatch. With distributed ledgers, that same data is instead held in an objective, globally accessible third party ledger that is stored, replicated, and updated, across every node in the network. This reduces the multiple communications, copies, and transmissions into a single, master record of the truth that all parties can point to and affirm or deny. Affirmation from all parties is referred to as “consensus.”

The exemplary embodiments presented here relate to reward systems, methods, protocols, procedures, and technology. The described subject matter can be implemented in the context of any computer-implemented reward system that uses blockchain (or equivalent) technologies to control distribution of crypto currencies among users associated with an organization. For example, in one implementation, the computer-implemented reward system uses blockchain (or equivalent) technologies to control distribution of digital crypto tokens among users who are associated with an organization.

As used herein, the term “cryptocurrency” can refer to a digital or virtual currency that is encrypted using cryptography. For example, a cryptocurrency can be a standard currency (e.g., Bitcoin) which is used for the purpose of making or receiving payments on a blockchain. Two other types of cryptocurrencies include “altcoins” and “crypto tokens.”

Altcoins (or “alternative cryptocurrency coins”) can refer to the various alternative cryptocurrencies other than bitcoins that have their own separate blockchain. Examples of altcoins can include Peercoin, Auroracoin, Litecoin, Bitcoin Cash, Namecoin and Dogecoin. Altcoins each possess their own independent blockchain, where transactions relating to their native coins occur. In essence, the cryptocurrencies and altcoins are specific virtual currencies that have their own dedicated blockchains and are primarily used as a medium for digital payments.

On the other hand, tokens are a representation of a particular asset or utility that usually resides on top of another blockchain. In other words, crypto tokens operate on top of a blockchain that acts as a medium for creation and execution of decentralized apps and smart contracts, and the tokens are used to facilitate the transactions. Crypto tokens can represent any particular fungible and tradable asset or a utility that is often found on a blockchain (e.g., commodities, loyalty points, other cryptocurrencies, etc.).

As used herein, the term “digital crypto token” can refer to a special kind of virtual currency token that resides on its own blockchain and represents an asset or utility. Crypto tokens often serve as the transaction units on blockchains. These blockchains work on the concept of smart contracts or decentralized applications, where the programmable, self-executing code is used to process and manage the various transactions occurring on the blockchain. The crypto tokens are tradable and transferrable among the various participants of a blockchain. For example, one can have a crypto token that represents x number of customer loyalty points on a blockchain that is used to manage such details for a retail chain. There can be another crypto token that gives entitlement to the token holder to view 10 hours of streaming content on a video-sharing blockchain. Another crypto token can represent another cryptocurrency, like one such token being equal to 15 bitcoins on a particular blockchain.

In one embodiment, a method is provided for controlling distribution of digital crypto tokens to users associated with an organization (e.g., employees of the organization). Depending on the implementation, a pool of digital crypto tokens for the organization and a distributed ledger in a blockchain is stored within a distributed database system or cloud computing platform. The blockchain comprises a network of blockchain nodes. The digital crypto tokens (e.g., Ethereum tokens) can be classified as either “granted” digital crypto tokens or “transferable” digital crypto tokens. The digital crypto tokens are redeemable for one or more of: money; gifts; privileges; sponsorship of a charitable contribution, a team event, conferences and educational training sessions; awards or recognition within the organization; meetings with others within the organization; and assistance from others within the organization. Distribution of the digital crypto tokens to users associated with the organization is controlled by validating each transaction involving the digital crypto tokens at a smart contract module prior to issuing digital crypto tokens to users of the organization. For example, at least one smart contract is used for each transaction to directly control peer-to-peer transfer of the transferable digital crypto tokens between users. A peer-to-peer employee reward system (e.g., that is integrated within a cloud computing platform) issues the granted digital crypto tokens to users as a reward when a user performs certain tasks. Each granted digital crypto token quantifies time spent performing a certain task and serves as a currency within the organization.

In one embodiment, the reward system includes a user interface (UI) generator module that, when executed by a hardware-based processing system, generates at least one user interface at a computer of at least one user. The user interface can include a token summary UI element that displays a current balance of digital crypto tokens possessed by a particular user, and a number of transferrable digital crypto tokens that are currently transferrable by the particular user to other users within the organization. The user interface can also include a timeline UI element configurable to display an activity timeline that indicates recent token transactions that relate to the particular user. The user interface can also include a token trend UI element that displays a graph that illustrates a summary of a running total number of the digital crypto tokens possessed by the particular user at various points during a time period. The user interface can also include a recommendation UI element configurable to display a list of other users that the reward system recommends for potentially transferring the transferrable digital crypto tokens to. The user interface can also include a team UI element configurable to display a list of team members with a summary of a total number of the digital crypto tokens possessed by each team member. The user interface can also include a leader UI element configurable to display a leader board for the organization where top users having the most digital crypto tokens are displayed along with a ranking and a total number of digital crypto tokens possessed by each of the top users listed in the leader board.

In another embodiment, a system is provided that includes a cloud computing platform comprising a server system and a database system; a distributed database system; and a reward system. In one embodiment, the distributed database system can store a pool of digital crypto tokens for an organization and a distributed ledger in a blockchain that comprises a network of blockchain nodes. The network of blockchain nodes collectively store the distributed ledger. The distributed ledger is configured to track and control distribution of the digital crypto tokens to users associated with the organization. Each of the digital crypto tokens can be classified as being either a granted digital crypto token or a transferrable digital crypto token. The system can include a smart contract module that is implemented at either the distributed database system or the cloud computing platform depending on the implementation. When executed by a hardware-based processing system, the smart contract module can validate each transaction involving the digital crypto tokens, prior to issuing digital crypto tokens to users of the organization. For example, one or more smart contracts can be used for each transaction to directly control peer-to-peer transfer of the transferrable digital crypto tokens between users. A reward system can be integrated with the cloud computing platform and/or with the distributed database system depending on the implementation. The reward system can include a reward module, that when executed by a hardware-based processing system, is configurable to cause: the granted digital crypto tokens to be issued to at least one user as a reward when the user performs certain tasks. Each of the granted digital crypto token quantifies time spent performing a certain task and serves as a currency within the organization.

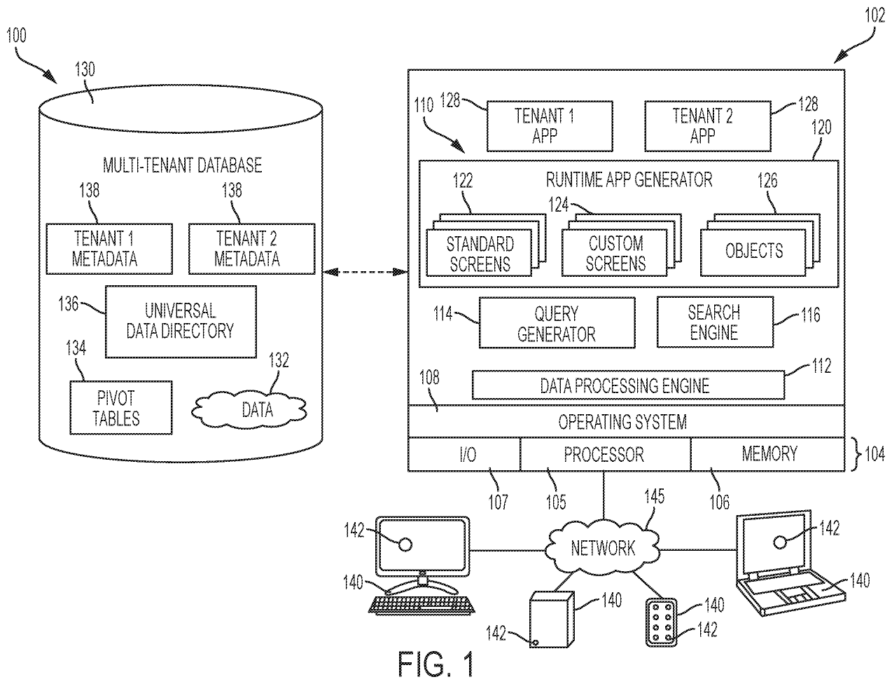

FIG. 1 is a schematic block diagram of an example of a multi-tenant computing environment in which features of the disclosed embodiments can be implemented in accordance with the disclosed embodiments. As shown in FIG. 1, an exemplary cloud-based solution may be implemented in the context of a multi-tenant system 100 including a server 102 that supports applications 128 based upon data 132 from a database 130 that may be shared between multiple tenants, organizations, or enterprises, referred to herein as a multi-tenant database. Data and services generated by the various applications 128 are provided via a network 145 to any number of user systems 140, such as desktops, laptops, tablets, smartphones or other client devices, Google Glass™, and any other computing device implemented in an automobile, aircraft, television, or other business or consumer electronic device or system, including web clients.

Each application 128 is suitably generated at run-time (or on-demand) using a common application platform 110 that securely provides access to the data 132 in the database 130 for each of the various tenant organizations subscribing to the system 100. In accordance with one non-limiting example, the service cloud 100 is implemented in the form of an on-demand multi-tenant customer relationship management (CRM) system that can support any number of authenticated users for a plurality of tenants.

As used herein, a “tenant” or an “organization” should be understood as referring to a group of one or more users (typically employees) that shares access to common subset of the data within the multi-tenant database 130. In this regard, each tenant includes one or more users and/or groups associated with, authorized by, or otherwise belonging to that respective tenant. Stated another way, each respective user within the multi-tenant system 100 is associated with, assigned to, or otherwise belongs to a particular one of the plurality of enterprises supported by the system 100.

Each enterprise tenant may represent a company, corporate department, business or legal organization, and/or any other entities that maintain data for particular sets of users (such as their respective employees or customers) within the multi-tenant system 100. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other organizations.

The multi-tenant database 130 may be a repository or other data storage system capable of storing and managing the data 132 associated with any number of tenant organizations. The database 130 may be implemented using conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

In an exemplary embodiment, the database 130 includes a database management system or other equivalent software capable of determining an optimal query plan for retrieving and providing a particular subset of the data 132 to an instance of application (or virtual application) 128 in response to a query initiated or otherwise provided by an application 128, as described in greater detail below. The multi-tenant database 130 may alternatively be referred to herein as an on-demand database, in that the database 130 provides (or is available to provide) data at run-time to on-demand virtual applications 128 generated by the application platform 110, as described in greater detail below.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants.

Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 may be implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like.

The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or platform, e.g., a portable hard drive, a USB flash drive, an optical disc, or the like.

The application platform 110 is any sort of software application or other data processing engine that generates the virtual applications 128 that provide data and/or services to the user systems 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the user systems 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the user systems 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its user system 140, as appropriate.

The runtime application generator 120 suitably interacts with the query generator 114 to efficiently obtain multi-tenant data 132 from the database 130 as needed in response to input queries initiated or otherwise provided by users of the user systems 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

With continued reference to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still referring to FIG. 1, the data and services provided by the server 102 can be retrieved using any sort of personal computer, mobile telephone, tablet or other network-enabled user system 140 on the network 145. In an exemplary embodiment, the user system 140 includes a display device, such as a monitor, screen, or another conventional electronic display capable of graphically presenting data and/or information retrieved from the multi-tenant database 130, as described in greater detail below.

Typically, the user operates a conventional browser application or other client program 142 executed by the user system 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. However, if a user chooses to manually upload an updated file (through either the web based user interface or through an API), it will also be shared automatically with all of the users/devices that are designated for sharing.

As noted above, the virtual application 128 may contain Java, ActiveX, or other content that can be presented using conventional client software running on the user system 140; other embodiments may simply provide dynamic web or other content that can be presented and viewed by the user, as desired. As described in greater detail below, the query generator 114 suitably obtains the requested subsets of data 132 from the database 130 as needed to populate the tables, reports or other features of the particular virtual application 128. In various embodiments, application 128 embodies the functionality of a collaboration solution such as the Chatter system, described below.

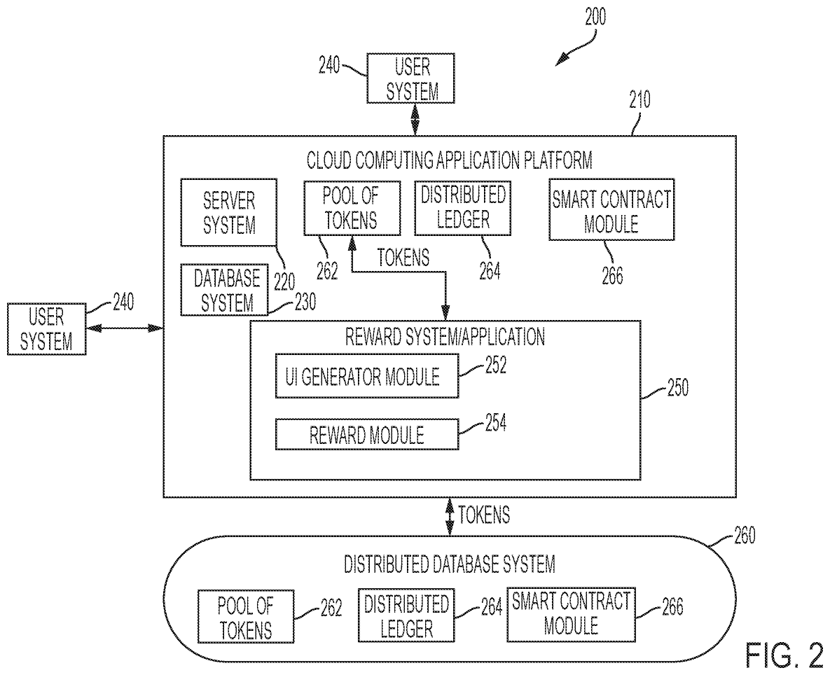

FIG. 2 is a block diagram of a peer-to-peer rewards system 200 in accordance with the disclosed embodiments. The system 200 includes a cloud computing platform 210 that includes a server system 220, a database system 230 and an automated reward application or system 250; any number of user systems 240 (although two are illustrated for sake of simplicity) of an organization; and a distributed database system 260. Each computer system shown in FIG. 1 (e.g., the cloud computing platform 210, its server system 220, database system 230 and the automated reward system 250; as well as the user systems 240 and the distributed database system 260) can be implemented using any computer or processor-based computing device that includes at least one processor, some form of memory hardware, and communication hardware to transmit and receive data transmissions.

The configuration of the system 200 can vary depending on the implementation. For example, in one embodiment, the pool of tokens 262, the distributed ledger 264 and the smart contract module 266 can be implemented at a distributed database system 260 as smart contract blockchain configuration that is designed to encourage users within an organization to exchange tokens as rewards for helping other users. In this embodiment, the system is built on a blockchain at the distributed database system 260. In this implementation, the system is “self-managing” in that it is autonomous and maintains itself once it is configured and deployed. There is no need to monitor or manage the peer-to-peer rewards system. The peer-to-peer rewards system is secure and self-managing. The smart contract module 266 can be part of the distributed ledger 264, but it illustrated separately for illustration purposes. In some non-limiting embodiments, smart contracts may be used to enable reward application 250 to interact with the distributed ledger 264.

In another embodiment, the automated, internal employee reward system 250 is deployed at the cloud computing platform 210 (e.g., Salesforce.com platform) and integrates with other systems that are part of the cloud computing platform 210. For example, the pool of tokens 262, the distributed ledger 264 and the smart contract module 266 can be implemented at an application layer of the cloud computing application platform 210. In this embodiment, an administrator of the organization manages the rewards system.

In the description that follows, it should be appreciated that while FIG. 2 illustrates a simplified example with two user systems, but that any number of user systems can be included in a practical implementation. The user systems 240 can be any type of computer is capable of connecting to and communicating over a data communication network (not illustrated). For example, the user systems can be a handheld computing device, a mobile phone, a laptop computer, a work station, and/or a network of computing devices. The data communication network that the user systems communicate over can be any one or any combination of a local area network (LAN), wide area network (WAN), telephone network, wireless network, point-to-point network, star network, token ring network, hub network, or other appropriate configuration. The data communication network provides and supports data connectivity between the user systems 240 and other elements of the system 200. In practice, the data communication network may be any digital or other communications network capable of transmitting messages or data between devices, systems, or components. In certain embodiments, the data communication network includes a packet switched network that facilitates packet-based data communication, addressing, and data routing. The packet switched network could be, for example, a wide area network, the Internet, or the like. In various embodiments, the data communication network includes any number of public or private data connections, links or network connections supporting any number of communications protocols. The data communication network may include the Internet, for example, or any other network based upon a transfer control protocol and Internet protocol (TCP/IP) or other conventional protocols. That network will be used in many of the examples herein. However, it should be understood that the networks used with the embodiment described herein use are not so limited, although TCP/IP is a frequently implemented protocol. In various embodiments, the data communication network could also incorporate a wireless and/or wired telephone network, such as a cellular communications network for communicating with mobile phones, personal digital assistants, and/or the like. The data communication network may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol.

In one implementation, the users of the user systems 240 are employees of the organization, and the reward system 250 is an internal, peer-to-peer employee reward system 250 for the organization. Users can be granted tokens by the reward system 250 upon establishing an account, and/or on a regular basis after establishing an account. Users can also earn tokens by performing certain tasks. The tokens are a trusted, decentralized, peer-to-peer form of currency that reward employees, and helps to quantify hours spent on rendering tasks and services which cannot be measured otherwise (like helping others, answering questions, solving technical issues, resolving conflicts, etc.). In one embodiment, the reward system 250 is maintained in private fork of Ethereum and makes use of smart contracts that can directly control the transfer of digital reward tokens between users under certain conditions. The tokens can be transferred from one user to other users (e.g., transferred from one employee to another).

As will be explained below, the reward application 250 can grant tokens to users of the organization. Those types of tokens can generally be referred to as “granted tokens.” In addition, users of the organization can also transfer tokens to other users of the organization. Those types of tokens can generally be referred to as “transferable tokens” or “transferred tokens.” Different smart contracts govern the different types of tokens. For example, in one embodiment, the granted tokens are valid for a time period that is greater than time periods that the transferred tokens are valid for. The tokens can be exchanged for monetary value, awards and recognition.

The distributed database system 260 is a distributed database that is distributed across a network of interconnected computer nodes (also referred to herein as blockchain nodes), where each node in a decentralized system stores a complete copy of a distributed ledger 264 that can be implemented as a public or private blockchain system. The network of blockchain nodes (not illustrated) collectively store the distributed ledger 264. The distributed database system 260 can also store a pool 262 of digital crypto tokens (e.g., Ethereum tokens issued by the Ethereum Foundation) for the organization and controls distribution of the digital crypto tokens to users associated with the organization. In one implementation, the pool 262 is a global pool of coins with a certain value and that is shared by the whole organization.

Any transactions with respect to the pool of tokens 262 are recorded in the distributed ledger 264. The distributed ledger 264 maintains a continuously-growing list of data records, called blocks, which are hardened against tampering and revision. The distributed ledger 264 can record transactions between users efficiently and in a verifiable and permanent way. The distributed ledger 264 may comprise any type of data model for structuring the tokens and associated rewards data stored therein. For example, in non-limiting embodiments, various tables or objects may be used to structure the tokens and associated rewards data stored therein. A program table may store the tokens and associated rewards data stored, whereas a user table may store information about users. The distributed ledger 264 can keep track of the fact that events/transactions have happened, and by design, is resistant to modification of the data. Data quality is maintained by massive database replication and computational trust. No centralized “official” copy exists and no user is “trusted” more than any other. The distributed ledger 264 can be managed by a peer-to-peer network collectively adhering to a protocol for inter-node communication and validating new blocks.

A blockchain includes a chain of linked blocks that represent a complete transaction history. The records, or blocks, are linked to each other using cryptography. Each block includes the cryptographic hash of the prior block in the blockchain, linking the two. The linked blocks form a chain that represents a complete transaction history. In one embodiment, each block holds a batch of valid transactions that are hashed and encoded into a Merkle tree. Blockchain security methods include the use of public-key cryptography. Each block can include a reference that links that block to a previous block in the chain (e.g., a cryptographic hash of the previous block), a summary of the transaction data (e.g., generally represented as a Merkle tree root hash), a time stamp (e.g., Proof of Work) to serialize changes, and other information that went into creating the secure block. The reference that links that block to the previous block, and to each additional block, reinforces those before it. For example, each block can include a hash of the prior block thereby linking the blocks together. This iterative process confirms the integrity of the previous block, all the way back to the original genesis block.

In accordance with the disclosed embodiments, a “transaction” can refer to an act or event that relates to a token being granted to a user or a token being transferred to or from a user. Transactions are broadcast to the network using software. Messages are delivered on a best-effort basis. Mining nodes validate transactions, add them to the block they are building, and then broadcast the completed block to other nodes. One or more components of a transaction can be recorded in a block of the blockchain to represent that the transaction has occurred (e.g., serve as information that represents that the transaction occurred). This information can then be used to verify or prove or represent the fact that the transaction occurred. After the transaction is recorded, it must then be validated before being added into the blockchain.

To explain further, a transaction is not added to the blockchain until it is recognized as valid. For a transaction to be added to a blockchain, other participants in the given system must approve/validate the transaction. This helps ensure that only valid transactions are added to the blockchain. To validate the transaction, the transaction can be sent (e.g., broadcast) to nodes of other participants who are part of (or belongs to) a given system. Each node can validate a transaction, add it to their copy of the blockchain and then broadcast the addition to other nodes. After a number of those other participants approve or validate the transaction, the transaction can be added to the chain, which provides a record of the transactions existence. This record cannot be tampered with because each of the other participants has a copy.

The distributed ledger 264 (also called a shared ledger or distributed ledger technology) can be spread across several nodes (devices) on a peer-to-peer network. Each node replicates and saves an identical copy of the ledger and updates itself independently. A peer-to-peer network and consensus algorithms help ensure replication across nodes is undertaken. The distributed ledger 264 can represent a consensus of replicated, shared, and synchronized digital data geographically spread across multiple sites, countries, or institutions. There is no central authority, administrator or centralized data storage. One advantage of this technology is the lack of central authority. When a ledger update happens, each node constructs the new transaction, and then the nodes vote by consensus algorithm on which copy is correct. Once a consensus has been determined, all the other nodes update themselves with the new, correct copy of the ledger. Security is accomplished through cryptographic keys and signatures.

Once recorded, the data in any given block cannot be altered retroactively without alteration of all subsequent blocks, which requires consensus of the network majority. By storing data across its peer-to-peer network, the blockchain eliminates a number of risks that come with data being held centrally. Peer-to-peer blockchain networks lack centralized points of vulnerability that computer hackers can exploit; likewise, it has no central point of failure.

A fork can be defined as “what happens when a blockchain diverges into two potential paths forward,” or “a change in protocol” or a situation that “occurs when two or more blocks have the same block height.” Forks are related to the fact that different users need to use common rules to maintain the history of the blockchain. Forks (in the sense of protocol changes) have been used in order to add new features to a blockchain, to reverse the effects of hacking or catastrophic bugs on a blockchain. Forks can be classified as accidental or intentional. An accidental fork happens when two or more miners find a block at nearly the same time. The fork is resolved when subsequent block(s) are added and one of the chains becomes longer than the alternative(s). The network abandons the blocks that are not in the longest chain (they are called orphaned blocks). By contrast, intentional forks that modify the rules of a blockchain can be classified as follows either hard forks or soft forks. A hard fork is a rule change such that the software validating according to the old rules will see the blocks produced according to the new rules as invalid. In case of a hard fork, all nodes meant to work in accordance with the new rules need to upgrade their software. If one group of nodes continues to use the old software while the other nodes use the new software, a split can occur. In contrast to a hard fork, a soft fork is a change of rules that creates blocks recognized as valid by the old software, i.e. it is backwards-compatible. As for a hard fork, a soft fork can also split the blockchain when non-upgraded software creates blocks not considered valid by the new rules.

The cloud computing platform 210 includes at least one hardware-based processor. The at least one processor may be implemented using one or more general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In particular, the at least one processor may be realized as one or more microprocessors, controllers, microcontrollers, or state machines. Moreover, the at least one processor may be implemented as a combination of computing devices, e.g., a combination of digital signal processors and microprocessors, a plurality of microprocessors, one or more microprocessors in conjunction with a digital signal processor core, or any other such configuration

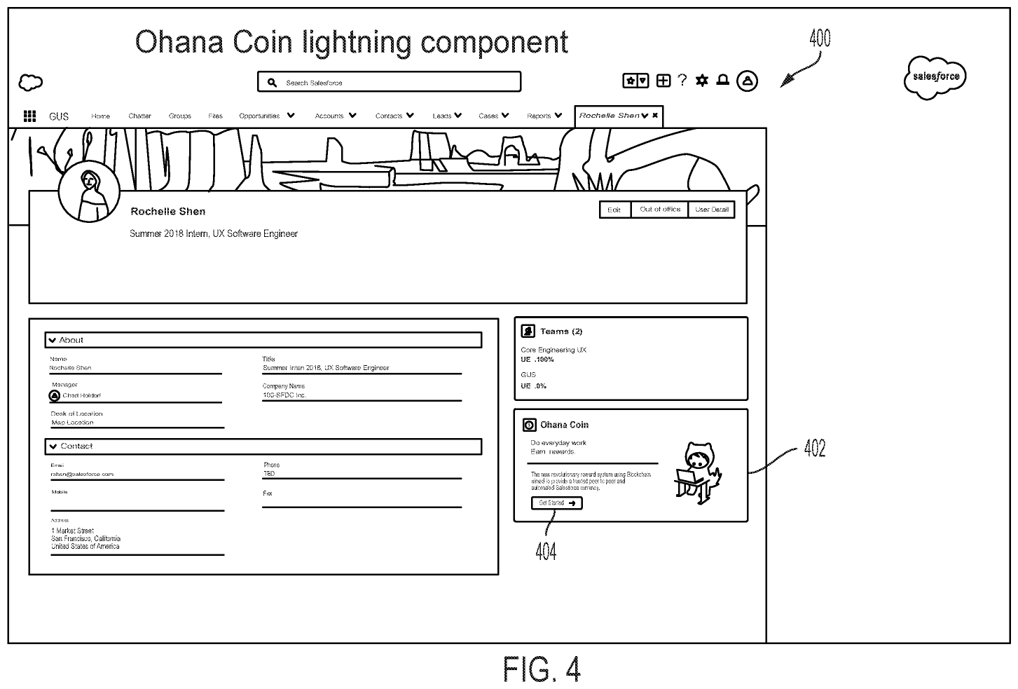

The reward system 250 is communicatively coupled to and integrated with the cloud computing platform 210 and/or with the distributed database system 260. The reward system 250 includes a UI generator module 252, a reward module 254 and a smart contract module 266. The UI generator module 252 generates various user interfaces that are displayed at user's computers when they interact with the reward system. Examples of these user interfaces will be described below with reference to FIGS. 4-9.

The reward module 254 issues digital crypto tokens to users as a reward when they perform certain tasks. Each digital crypto token quantifies time spent performing a certain task and serves as a currency within the organization.

The smart contract module 266 can validate transactions using one or more smart contracts for each transaction to directly control peer-to-peer transfer of the digital crypto tokens between the users under certain conditions. The smart contract module 266 includes a rules engine that executes a number of smart contracts that govern any transactions involving the pool of tokens in the distributed database system 260 and/or the cloud computing application platform 210. Any tokens that are granted or transferred to users must satisfy rules imposed by one or more smart contracts. For example, smart contracts can govern a maximum amount of tokens that can be transferred by a user, can specify duration or a time/date that tokens are valid for before they expire, can specify a maximum amount of tokens that can be granted to a user during a certain time period, etc. Each smart contract may be coded with logic that defines one or more rules governing transactions that involve tokens.

Users may perform one or more actions that provide input to the smart contract. For example, in some embodiments, the actions are or include inputting information to transfer tokens to other users. This action is processed using the public key held by the customer in order to verify the authenticity of the user's action(s), and the resulting encrypted action information is input into the smart contract. The smart contract, using embedded logic (i.e., rules-based logic) can decrypt the encrypted action information and determine if it validates the message based on the terms of the smart contract. If so, the smart contract enables delivery of the specified tokens to another user within the organization. The granting and transfer of tokens is visible on the blockchain network for full transparency into the smart contract and its use.

In one implementation, Ethereum validates the transactions using smart contracts for every transaction (e.g., an employee may not transfer more than 10 coins to another same employee in a week or employee's may only transfer coins from their allotted 30 coins and not from the global pool etc.).

A smart contract can refer to “a computerized transaction protocol that executes the terms of a contract.” A smart contract is not necessarily related to the classical concept of a contract, but can be any kind of computer program. A smart contract is often used in the sense of a computation that takes place on a blockchain or distributed ledger 264. With smart contracts, a program enforces the contract built into the code. Stated differently, a smart contract can refer to a computer protocol intended to digitally facilitate, verify, or enforce the negotiation or performance of a contract. Blockchain-based smart contracts are contracts that could be partially or fully executed or enforced without human interaction. Smart contracts allow the performance of credible transactions without third-party users. These transactions are trackable and irreversible. In one embodiment, smart contract infrastructure can be implemented by replicated asset registries and contract execution using cryptographic hash chains and Byzantine fault tolerant replication. Bitcoin can be used for replicated asset registration and contract execution is called “colored coins.”

Users of the organization can earn tokens by performing certain tasks. Some non-limiting examples include rendering services to other users such as technical assistance or responses to questions asked by other users (e.g., employees receive coins when they perform tasks like, helping on chatter, resolving P4 issues, answering questions etc.); speaking at events or conferences; publishing information (e.g. publishing information on a blog at Salesforce.com); when accepting a new task, role or responsibility within the organization (e.g., new hires to use them for training. Giving out coins during new hire training and internal trainings for those who collaborate and help others out. New hires can use these coins for completing certifications, trainings or courses.

Any user can redeem or exchange tokens for a variety of different things. For example, the digital crypto tokens are redeemable or exchangeable for one or more of money (e.g., spot bonuses); gifts (e.g., actual gifts including gift cards); and privileges. For instance, employees can redeem their digital crypto tokens for real money (e.g., 1 coin can be exchanged for some amount of money taking into account a currency conversion rate in the particular country). Digital crypto tokens can also be redeemed for merchandise at a company store. As another example, digital crypto tokens can also be used to reserve rooms at company facilities, or upgrade computer technologies (e.g., earlier mobile or laptop upgrade).

The digital crypto tokens can also be exchangeable for one or more of sponsorship of a charitable contribution (e.g., donating a certain amount to a charity of the user's choice); sponsorship of a team event (e.g., team members can pool their tokens together to pay for a team event); and sponsorship for conferences and educational training sessions (e.g., use tokens to attend important conferences). The digital crypto tokens can also be exchangeable for one or more of awards within the organization (e.g., tokens can be used to nominate someone for an All-Star award); recognition within the organization (e.g., to nominate someone for a promotion); meetings with others within the organization (e.g., meetings with top executives within the organization); and assistance from others within the organization.

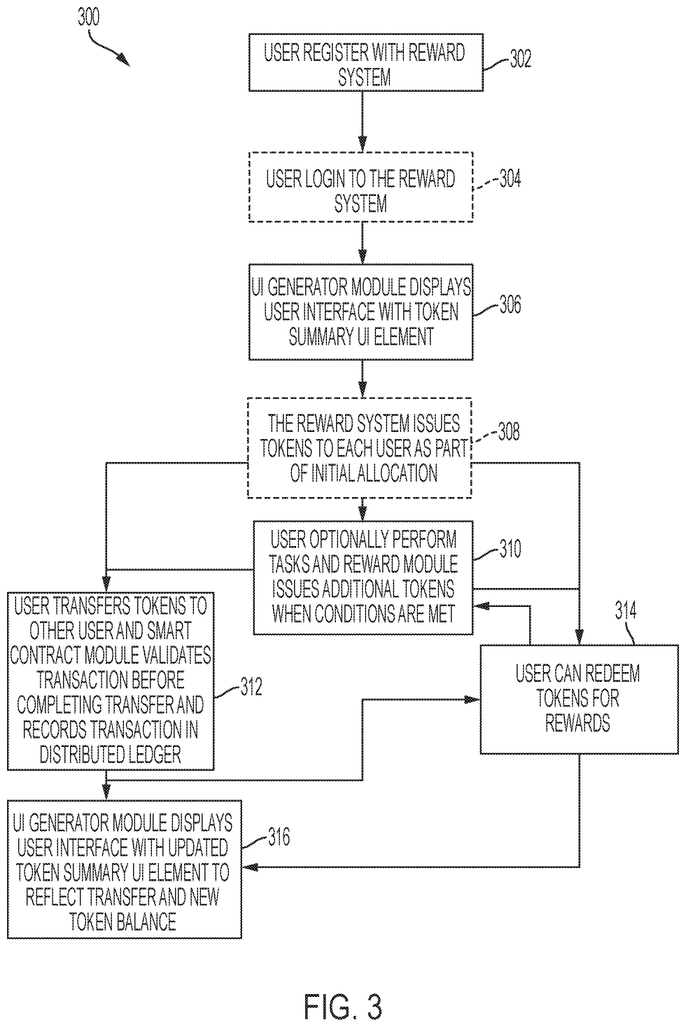

FIG. 3 is a flow chart that illustrates an exemplary method 300 for registering a user with the reward system and then using the reward system in accordance with the disclosed embodiments. As a preliminary matter, it should be understood that steps of the method 300 are not necessarily limiting, and that steps can be added, omitted, and/or performed simultaneously without departing from the scope of the appended claims. It should be appreciated that the method 300 may include any number of additional or alternative tasks, that the tasks shown in FIG. 3 need not be performed in the illustrated order, and that the method 300 may be incorporated into a more comprehensive procedure or process having additional functionality not described in detail herein. Moreover, one or more of the tasks shown in FIG. 3 could be omitted from an embodiment of the method 300 as long as the intended overall functionality remains intact. It should also be understood that the illustrated method 300 can be stopped at any time. The method 300 is computer-implemented in that various tasks or steps that are performed in connection with the method 300 may be performed by software, hardware, firmware, or any combination thereof. For illustrative purposes, the following description of the method 300 may refer to elements mentioned above in connection with FIG. 2. In certain embodiments, some or all steps of this process, and/or substantially equivalent steps, are performed by execution of processor-readable instructions stored or included on a processor-readable medium. In addition, it should be noted that the methodology 300 in FIG. 3 will be described with reference to a single user who registers with and then utilizes the reward system, but the general methodology is applicable to multiple users who part of an organization and utilizing the reward system.

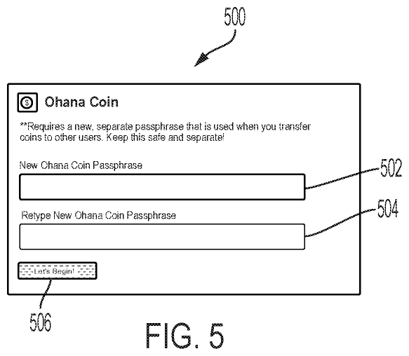

The method 300 begins at 302 when a user registers with the reward system. This can be done using the user interfaces that will be described below with reference to FIGS. 4 and 5. The method 300 may then optionally proceed to 304 or the user logs into the reward system; however, it should be appreciated that this step is not necessary in some implementations, for example, when the user is already logged into the cloud computing platform that also hosts the reward system.

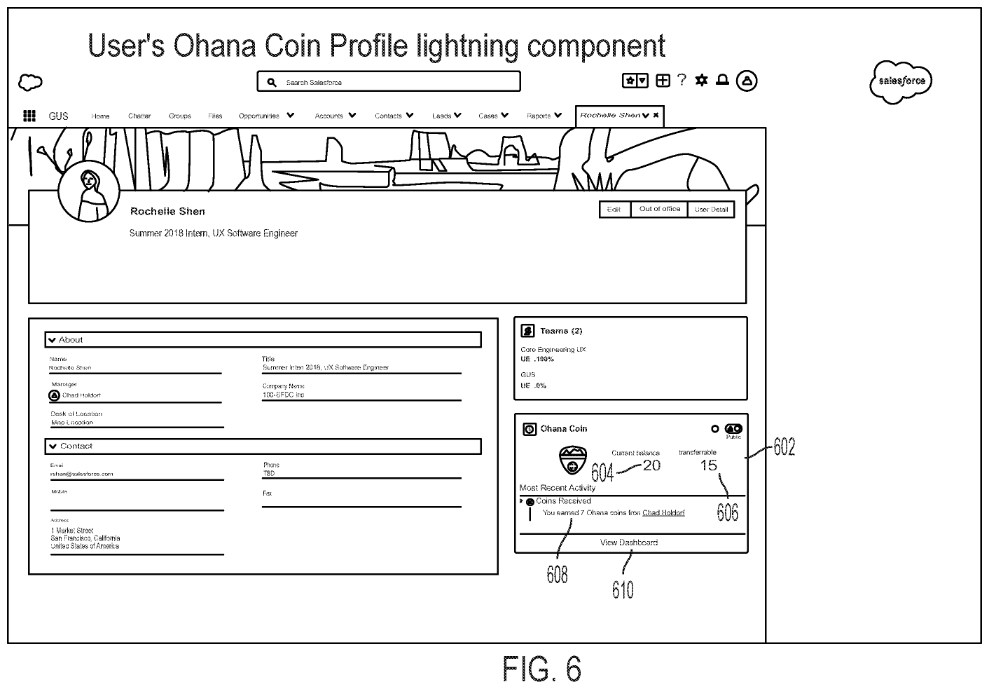

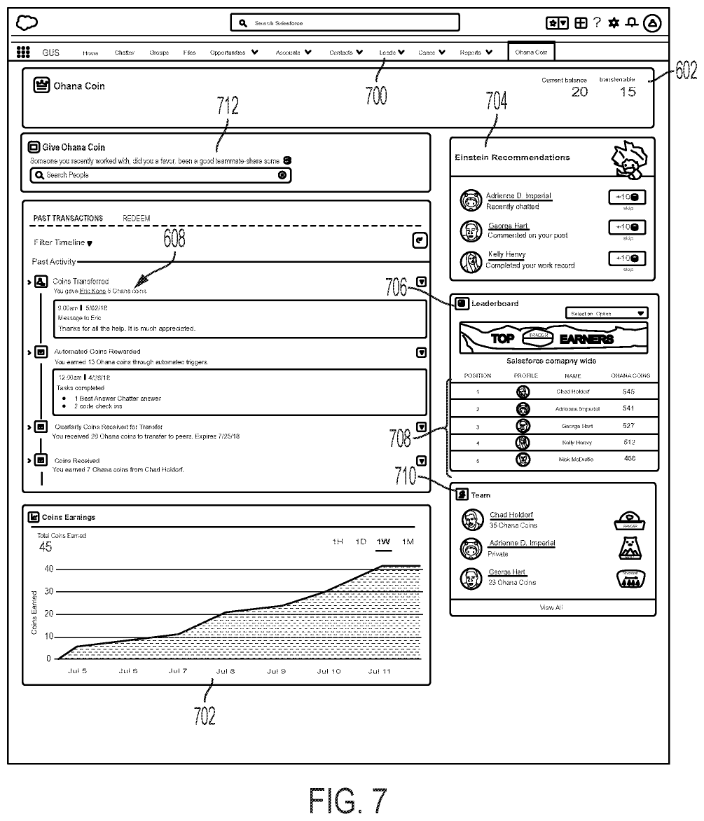

The method 300 then proceeds to 306, where the UI generator module of the reward system causes a user interface to be displayed having at least a token summary user interface element (as described below with reference to FIG. 6). In other implementations, the UI generator module causes a reward system dashboard user interface to be displayed that will be described below with reference to FIGS. 7-9.

At step 308, the reward system issues tokens to the user, for example, as part of an initial or ongoing allocation procedure. Step 308 is optional. It can occur when the user initially registers with the reward system, or alternatively, on a regular schedule when the user is allocated additional tokens. In one implementation, the tokens issued at 308 by the reward system can only be transferred to other users who are part of the organization and using the reward system.

At 310, the reward module of the reward system can issue additional tokens to the user when the user performs certain tasks that meet certain conditions or automatic triggers that are monitored by the reward system. In other words, the reward system can automatically issue tokens to a user when that user perform certain tasks as described above. The tokens that are issued at 310 can be redeemed by the user as described above, and/or be transferred by the user to other users.

At 312, the user can transfer tokens to other users. When the user attempts to transfer the tokens, the smart contract module validates the transaction before completing the transfer and records the transaction in the distributed ledger. In addition, at 314, the user can redeem some of the tokens that they have earned for various rewards as described above. Again, before the user can redeem any tokens, the smart contract module validates the transaction before completing the process and then records the transaction in the distributed ledger. Following either one of steps 312 and 314, the method 300 proceeds to 316, where the UI generator module causes a user interface to be displayed that includes, at a minimum, an updated token summary UI element to reflect the transfer of tokens to other users and the new transferrable token balance of tokens that can be transferred by the user to other users, or to reflect the redemption of tokens by the user and the new redeemable token balance of tokens that can be redeemed by the user. Similar to step 306, the UI generator module of the reward system could alternatively cause an updated version of the reward system dashboard user interface (as will be described below with reference to FIGS. 7-9) to be displayed at 316.

FIG. 4 is a screenshot 400 that shows an example of user interface in accordance with the disclosed embodiments. In this embodiment, a user, Rochelle Shen, is logged into her account within the cloud computing platform and has already been authenticated. The user interface includes a rewards system registration element 402. When the user selects “Get Started” action button 404, this opens another registration user interface element 500 shown in FIG. 5. The registration user interface element 500 includes text fields 502, 504 that allows the user to input a passphrase that will be used when they transfer tokens to other users. In other words, the user enters a unique password or passphrase that is used to authorize token transactions when using the reward system 250. Once the user has entered their passphrase for the rewards system in both boxes 502, 504, the user can select the Let's Begin! action button 506. This automatically creates an account with the reward system 250, and in one implementation, also automatically creates a user account in the distributed database system 260 (e.g., Ethereum). This also updates the user interface as shown in FIG. 6

FIG. 6 is a screenshot 600 that shows an example of a token profile user interface element 602 in accordance with the disclosed embodiments. The token profile user interface element 602 includes a token summary UI element 602 that displays a current balance 604 of digital crypto tokens possessed by this particular user, and a number 606 of the digital crypto tokens that are currently transferrable by this particular user to other users who are part of the organization. In this example, it is assumed that upon creating an account with the rewards system, each employee is given 30 tokens, which have an expiry on them. This can be done every month, but these free tokens expire if not shared within a particular time period. Although not illustrated in FIG. 6, the token profile user interface element 602 can also include a list of icons for various types of rewards that tokens can be redeemed for, and when a user hovers over one of the reward icons in the list, a corresponding number of digital crypto tokens required to redeem for that reward can be displayed as an overlay on the reward icon that is being hovered over.

The token profile user interface element 602 also includes a timeline UI element 608. The timeline UI element displays an activity timeline 608 that indicates recent token activity and transactions that relate to the particular user. In the particular example shown in FIG. 6, there is only one event on the activity timeline at this point, which shows that the user was transferred 7 tokens from a user named Chad Holdorf. The token profile user interface element 602 also includes a hyperlink 610 that allows the user to view a reward system dashboard when the user selects the hyperlink 610.

FIGS. 7-9 are screenshots 700, 800, 900 that show an example of a reward system dashboard user interface in accordance with the disclosed embodiments. The reward system dashboard user interface also includes a token profile user interface element 602 and a timeline UI element 608 similar to those discussed above with reference to FIG. 6, but also includes a number of other user interface elements that provide additional information to the user. In particular, the dashboard user interface also includes a token trend UI element 702 that displays a graph that illustrates a summary of a running total number of the digital crypto tokens possessed by the particular user at various points during a time period; a recommendation UI element 704 that displays a list of other users that the reward system 250 recommends for potentially transferring digital crypto tokens to; a leader UI element 706 that displays a leader board 708; a team UI element 710 that displays a list of team members; and a token transfer UI element 712 that can be used to search for other users who the user might want to transfer tokens to. The leader UI element 706 can display the leader board 708 for the organization where top users having the most digital crypto tokens are displayed along with a ranking and a total number of digital crypto tokens possessed by each of the top users listed in the leader board. In one implementation, the team UI element 710 can display the list of team members with a summary of a total number of the digital crypto tokens possessed by each team member, and honorary badges for team members who have earned a certain number of digital crypto tokens. Each honorary badge reflects that a particular user has earned a certain number of digital crypto tokens. So, for example, if a user earns 50 digital crypto tokens they would receive a first type of honorary badge, and if the user earns 100 digital crypto tokens they would receive a second type of honorary badge that is more prestigious the first type of honorary badge, and so on. In addition, it should be noted that, while not illustrated in the other FIGS., these honorary badges could appear in proximity to and in conjunction with any other type of UI element that displays a user's profile, a user's name, a user's profile picture, or other information that identifies the user.

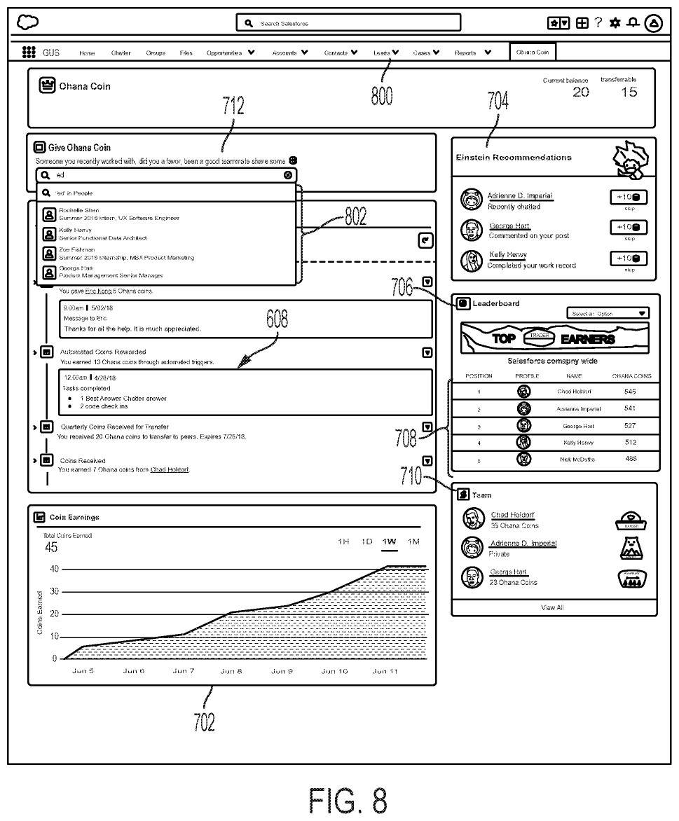

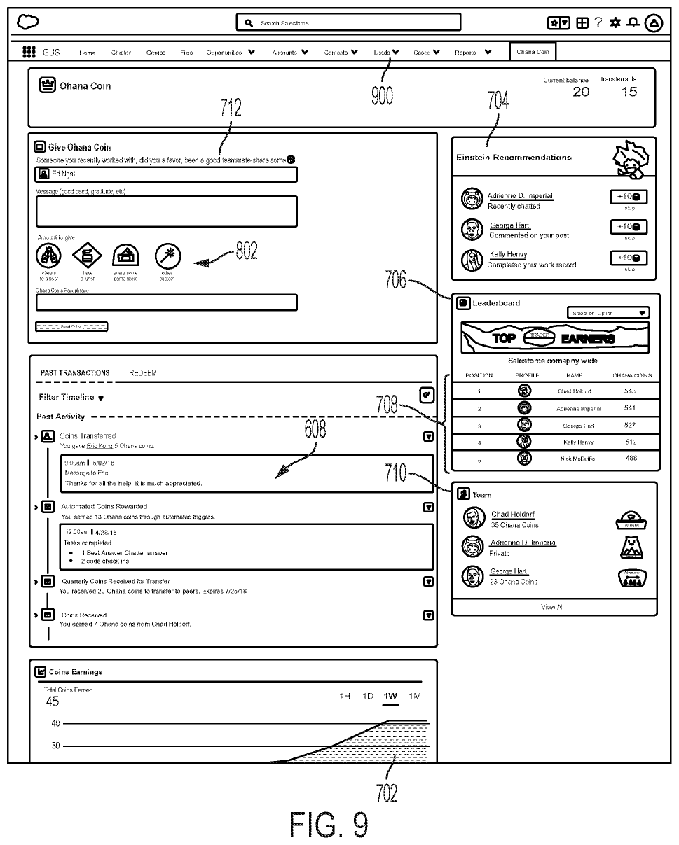

As noted above, the token transfer UI element 712 can be used to search for other users who the user might want to transfer tokens to, and in one implementation, when the user enters information into the text field (as shown in FIG. 8), a list 802 of potential matches appears as a dropdown menu in this implementation. The user can select a name from the list 802 to initiate a transaction to transfer token(s) to the selected user. As shown in FIG. 9, the token transfer UI element 712 can also include a list 802 of different types of reward icons (four in this non-limiting example) that tokens can potentially be redeemed for, and while not illustrated in FIG. 9, when a user hovers over one of the reward icons in the list, a corresponding number of digital crypto tokens required to redeem for that reward (as represented by the reward icon) can be displayed as an overlay on the reward icon that is being hovered over. This way, before the user transfers tokens to another user, the user knows what someone else could potentially redeem the tokens for.

In addition, it should be noted that in the examples shown in FIGS. 7-9, the timeline UI element 608 displays past token transactions, but another options allows for a similar timeline UI element to be displayed that shows events where the user has redeemed their tokens. In this example, the timeline UI element 608 includes four past transactions (or events) that indicate recent token transactions that relate to the particular user. The events displayed in the timeline user interface element 608 can be displayed in reverse chronological order such that the most recent event appears first (at the top of the activity timeline). In this particular example there are four (4) transactions or events shown. The first event shows a transaction where the user gave Eric Kong five (5) tokens and then sent a message to Eric saying “Thanks for all the help. It is much appreciated.” The second event shows a transaction where the user has been rewarded 13 tokens through certain automated triggers that are part of the reward system. Beneath the second event is a summary of various tasks that were completed by the user to earn the 13 tokens. One task was a best answer in a social media forum, namely a Chatter® answer, and the second tasks the user completed were to code check-ins. Although not illustrated, in another embodiment, the number of coins awarded for each of the tasks could also be displayed in the summary panel each time coins are awarded to the user. The third event shows a transaction where the user was given 20 tokens to transfer to other users. In this implementation, the 20 tokens have an expiration date of Jul. 25, 2018. The 20 tokens that were transferred to the user could be a regular quarterly event in one nonlimiting implementation. The idea here is that these free tokens should be transferred to other users, and are not used or redeemable by the particular user. The fourth event shows a transaction where the user received seven (7) tokens from another user Chad Holdorf.

The following description is of one example of a system in which the features described above may be implemented. The components of the system described below are merely one example and should not be construed as limiting. The features described above with respect to FIGS. 1 and 2 may be implemented in any other type of computing environment, such as one with multiple servers, one with a single server, a multi-tenant server environment, a single-tenant server environment, or some combination of the above.

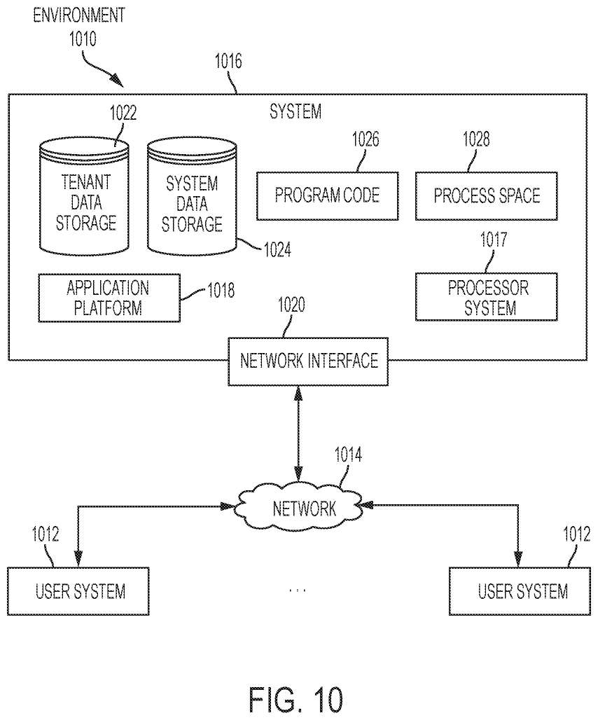

FIG. 10 shows a block diagram of an example of an environment 1010 in which an on-demand database service can be used in accordance with some implementations. The environment 1010 includes user systems 1012, a network 1014, a database system 1016 (also referred to herein as a “cloud-based system”), a processor system 1017, an application platform 1018, a network interface 1020, tenant database 1022 for storing tenant data 1023, system database 1024 for storing system data 1025, program code 1026 for implementing various functions of the system 1016, and process space 1028 for executing database system processes and tenant-specific processes, such as running applications as part of an application hosting service. In some other implementations, environment 1010 may not have all of these components or systems, or may have other components or systems instead of, or in addition to, those listed above.

In some implementations, the environment 1010 is an environment in which an on-demand database service exists. An on-demand database service, such as that which can be implemented using the system 1016, is a service that is made available to users outside of the enterprise(s) that own, maintain or provide access to the system 1016. As described above, such users generally do not need to be concerned with building or maintaining the system 1016. Instead, resources provided by the system 1016 may be available for such users' use when the users need services provided by the system 1016; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 1018 can be a framework that allows the applications of system 1016 to execute, such as the hardware or software infrastructure of the system 1016. In some implementations, the application platform 1018 enables the creation, management and execution of one or more applications developed by the provider of the on-demand database service, users accessing the on-demand database service via user systems 1012, or third party application developers accessing the on-demand database service via user systems 1012.

In some implementations, the system 1016 implements a web-based customer relationship management (CRM) system. For example, in some such implementations, the system 1016 includes application servers configured to implement and execute CRM software applications as well as provide related data, code, forms, renderable web pages and documents and other information to and from user systems 1012 and to store to, and retrieve from, a database system related data, objects, and Web page content. In some MTS implementations, data for multiple tenants may be stored in the same physical database object in tenant database 1022. In some such implementations, tenant data is arranged in the storage medium(s) of tenant database 1022 so that data of one tenant is kept logically separate from that of other tenants so that one tenant does not have access to another tenant's data, unless such data is expressly shared. The system 1016 also implements applications other than, or in addition to, a CRM application. For example, the system 1016 can provide tenant access to multiple hosted (standard and custom) applications, including a CRM application. User (or third party developer) applications, which may or may not include CRM, may be supported by the application platform 1018. The application platform 1018 manages the creation and storage of the applications into one or more database objects and the execution of the applications in one or more virtual machines in the process space of the system 1016.

According to some implementations, each system 1016 is configured to provide web pages, forms, applications, data and media content to user (client) systems 1012 to support the access by user systems 1012 as tenants of system 1016. As such, system 1016 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 1014 can be or include any network or combination of networks of systems or devices that communicate with one another. For example, the network 1014 can be or include any one or any combination of a LAN (local area network), WAN (wide area network), telephone network, wireless network, cellular network, point-to-point network, star network, token ring network, hub network, or other appropriate configuration. The network 1014 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 1012 can communicate with system 1016 using TCP/IP and, at a higher network level, other common Internet protocols to communicate, such as HTTP, FTP, AFS, WAP, etc. In an example where HTTP is used, each user system 1012 can include an HTTP client commonly referred to as a “web browser” or simply a “browser” for sending and receiving HTTP signals to and from an HTTP server of the system 1016. Such an HTTP server can be implemented as the sole network interface 1020 between the system 1016 and the network 1014, but other techniques can be used in addition to or instead of these techniques. In some implementations, the network interface 1020 between the system 1016 and the network 1014 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 1012 can be implemented as any computing device(s) or other data processing apparatus or systems usable by users to access the database system 1016. For example, any of user systems 1012 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 1012 typically executes an HTTP client, for example, a web browsing (or simply “browsing”) program, such as a web browser based on the WebKit platform, Microsoft's Internet Explorer browser, Netscape's Navigator browser, Opera's browser, Mozilla's Firefox browser, or a WAP-enabled browser in the case of a cellular phone, PDA or other wireless device, or the like, allowing a user (for example, a subscriber of on-demand services provided by the system 1016) of the user system 1012 to access, process and view information, pages and applications available to it from the system 1016 over the network 1014.

Each user system 1012 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 1012 in conjunction with pages, forms, applications and other information provided by the system 1016 or other systems or servers. For example, the user interface device can be used to access data and applications hosted by system 1016, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 1012 may differ in their respective capacities, and the capacity of a particular user system 1012 can be entirely determined by permissions (permission levels) for the current user of such user system. For example, where a salesperson is using a particular user system 1012 to interact with the system 1016, that user system can have the capacities allotted to the salesperson. However, while an administrator is using that user system 1012 to interact with the system 1016, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 1012 and some or all of its components are operator-configurable using applications, such as a browser, including computer code executed using a central processing unit (CPU) such as an Intel Pentium® processor or the like. Similarly, the system 1016 (and additional instances of an MTS, where more than one is present) and all of its components can be operator-configurable using application(s) including computer code to run using the processor system 1017, which may be implemented to include a CPU, which may include an Intel Pentium® processor or the like, or multiple CPUs.

The system 1016 includes tangible computer-readable media having non-transitory instructions stored thereon/in that are executable by or used to program a server or other computing system (or collection of such servers or computing systems) to perform some of the implementation of processes described herein. For example, computer program code 1026 can implement instructions for operating and configuring the system 1016 to intercommunicate and to process web pages, applications and other data and media content as described herein. In some implementations, the computer code 1026 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

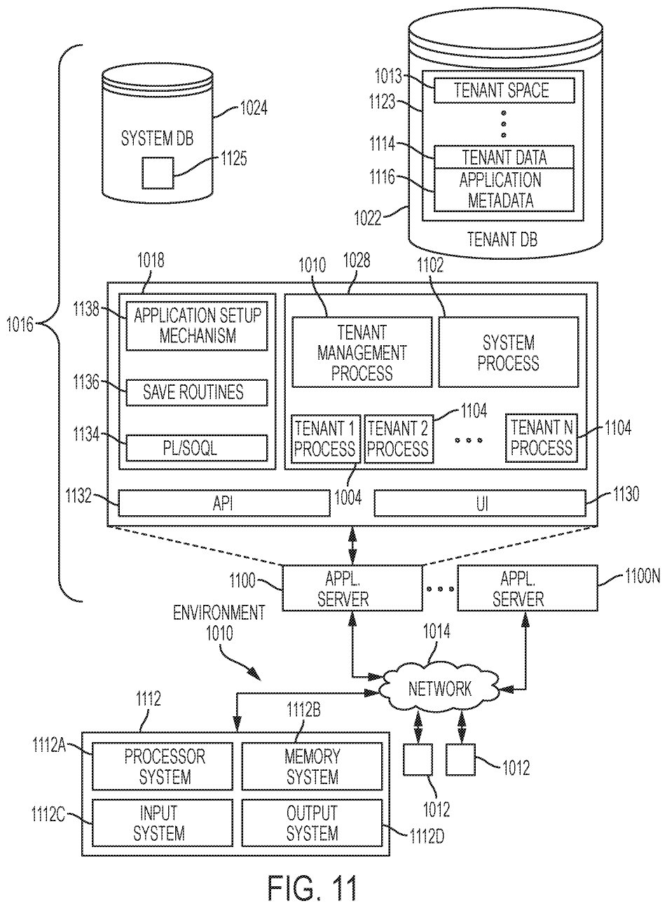

FIG. 11 shows a block diagram of example implementations of elements of FIG. 10 and example interconnections between these elements according to some implementations. That is, FIG. 11 also illustrates environment 1010, but in FIG. 11, various elements of the system 1016 and various interconnections between such elements are shown with more specificity according to some more specific implementations. Elements from FIG. 10 that are also shown in FIG. 11 will use the same reference numbers in FIG. 11 as were used in FIG. 10. Additionally, in FIG. 11, the user system 1012 includes a processor system 1112A, a memory system 1112B, an input system 1112C, and an output system 1112D. The processor system 1112A can include any suitable combination of one or more processors. The memory system 1112B can include any suitable combination of one or more memory devices. The input system 1112C can include any suitable combination of input devices, such as one or more touchscreen interfaces, keyboards, mice, trackballs, scanners, cameras, or interfaces to networks. The output system 1112D can include any suitable combination of output devices, such as one or more display devices, printers, or interfaces to networks.

In FIG. 11, the network interface 1020 of FIG. 10 is implemented as a set of HTTP application servers 1100₁-1100_{N}. Each application server 1100, also referred to herein as an “app server,” is configured to communicate with tenant database 1022 and the tenant data 1123 therein, as well as system database 1024 and the system data 1125 therein, to serve requests received from the user systems 1112. The tenant data 1123 can be divided into individual tenant storage spaces 1113, which can be physically or logically arranged or divided. Within each tenant storage space 1113, tenant data 1114 and application metadata 1116 can similarly be allocated for each user. For example, a copy of a user's most recently used (MRU) items can be stored to user storage 1114. Similarly, a copy of MRU items for an entire organization that is a tenant can be stored to tenant storage space 1113.

The process space 1028 includes system process space 1102, individual tenant process spaces 1104 and a tenant management process space 1110. The application platform 1018 includes an application setup mechanism 1138 that supports application developers' creation and management of applications. Such applications and others can be saved as metadata into tenant database 1022 by save routines 1136 for execution by subscribers as one or more tenant process spaces 1104 managed by tenant management process 1110, for example. Invocations to such applications can be coded using PL/SOQL 1134, which provides a programming language style interface extension to API 1132. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 816 for the subscriber making the invocation and executing the metadata as an application in a virtual machine.

The system 1016 of FIG. 11 also includes a user interface (UI) 1130 and an application programming interface (API) 1132 to system 1016 resident processes to users or developers at user systems 1112. In some other implementations, the environment 1010 may not have the same elements as those listed above or may have other elements instead of, or in addition to, those listed above.

Each application server 1100 can be communicably coupled with tenant database 1022 and system database 1024, for example, having access to tenant data 1123 and system data 1125, respectively, via a different network connection. For example, one application server 11001 can be coupled via the network 1014 (for example, the Internet), another application server 1100N can be coupled via a direct network link, and another application server (not illustrated) can be coupled by yet a different network connection. Transfer Control Protocol and Internet Protocol (TCP/IP) are examples of typical protocols that can be used for communicating between application servers 1100 and the system 1016. However, it will be apparent to one skilled in the art that other transport protocols can be used to optimize the system 1016 depending on the network interconnections used.

In some implementations, each application server 1100 is configured to handle requests for any user associated with any organization that is a tenant of the system 1016. Because it can be desirable to be able to add and remove application servers 1100 from the server pool at any time and for various reasons, in some implementations there is no server affinity for a user or organization to a specific application server 1100. In some such implementations, an interface system implementing a load balancing function (for example, an F5 Big-IP load balancer) is communicably coupled between the application servers 1100 and the user systems 1112 to distribute requests to the application servers 1100. In one implementation, the load balancer uses a least-connections algorithm to route user requests to the application servers 1100. Other examples of load balancing algorithms, such as round robin and observed-response-time, also can be used. For example, in some instances, three consecutive requests from the same user could hit three different application servers 1100, and three requests from different users could hit the same application server 1100. In this manner, by way of example, system 1016 can be a multi-tenant system in which system 1016 handles storage of, and access to, different objects, data and applications across disparate users and organizations.

In one example storage use case, one tenant can be a company that employs a sales force where each salesperson uses system 1016 to manage aspects of their sales. A user can maintain contact data, leads data, customer follow-up data, performance data, goals and progress data, etc., all applicable to that user's personal sales process (for example, in tenant database 1022). In an example of a MTS arrangement, because all of the data and the applications to access, view, modify, report, transmit, calculate, etc., can be maintained and accessed by a user system 1112 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 1016 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MTS. In addition to user-specific data and tenant-specific data, the system 1016 also can maintain system level data usable by multiple tenants or other data. Such system level data can include industry reports, news, postings, and the like that are sharable among tenants.

In some implementations, the user systems 1112 (which also can be client systems) communicate with the application servers 1100 to request and update system-level and tenant-level data from the system 1016. Such requests and updates can involve sending one or more queries to tenant database 1022 or system database 1024. The system 1016 (for example, an application server 1100 in the system 1016) can automatically generate one or more SQL statements (for example, one or more SQL queries) designed to access the desired information. System database 1024 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

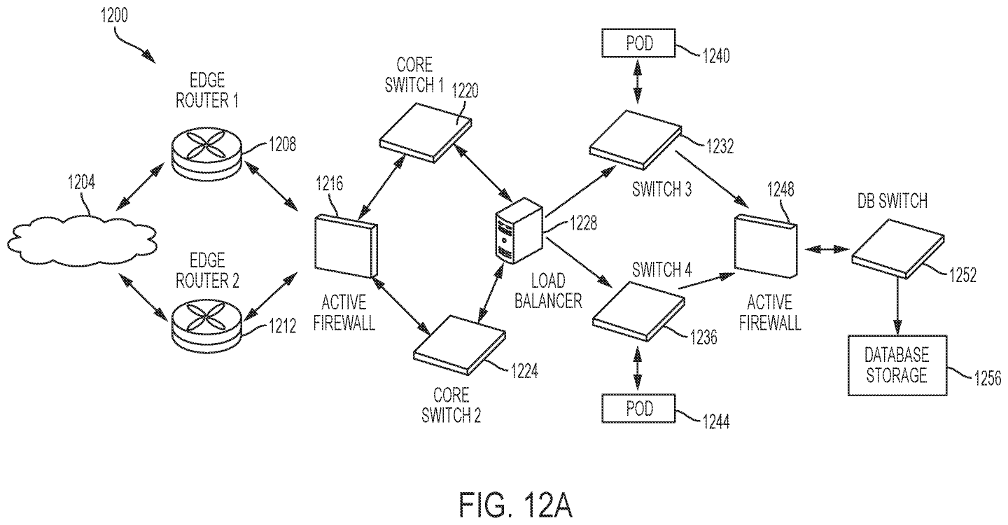

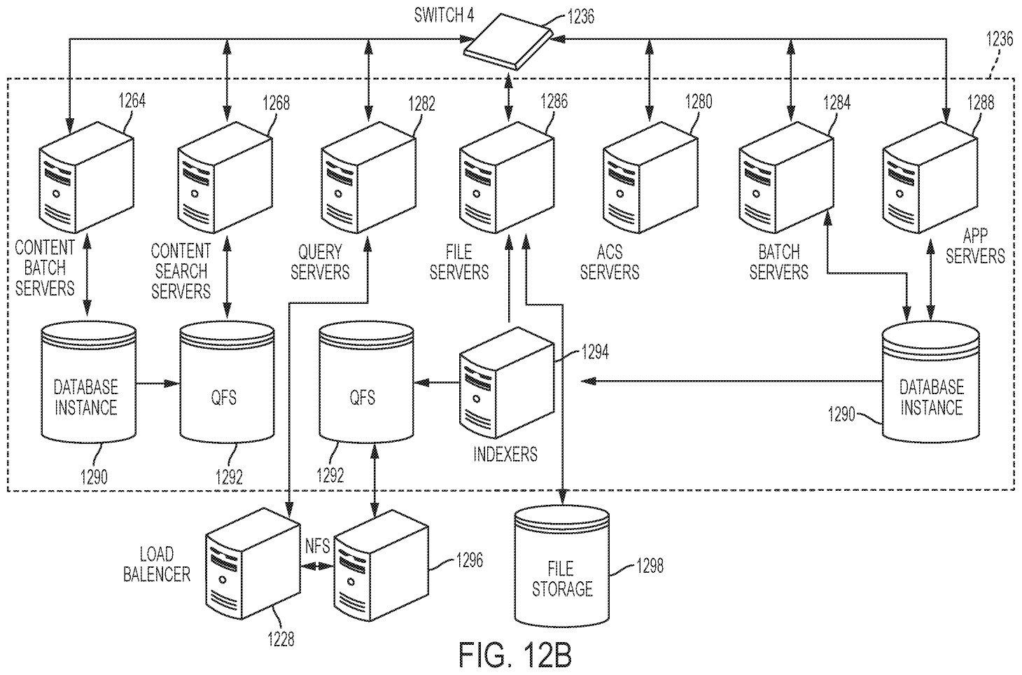

FIG. 12A shows a system diagram illustrating example architectural components of an on-demand database service environment 1200 according to some implementations. A client machine communicably connected with the cloud 1204, generally referring to one or more networks in combination, as described herein, can communicate with the on-demand database service environment 1200 via one or more edge routers 1208 and 1212. A client machine can be any of the examples of user systems 12 described above. The edge routers can communicate with one or more core switches 1220 and 1224 through a firewall 1216. The core switches can communicate with a load balancer 1228, which can distribute server load over different pods, such as the pods 1240 and 1244. The pods 1240 and 1244, which can each include one or more servers or other computing resources, can perform data processing and other operations used to provide on-demand services. Communication with the pods can be conducted via pod switches 1232 and 1236. Components of the on-demand database service environment can communicate with database storage 1256 through a database firewall 1248 and a database switch 1252.

As shown in FIGS. 12A and 12B, accessing an on-demand database service environment can involve communications transmitted among a variety of different hardware or software components. Further, the on-demand database service environment 1200 is a simplified representation of an actual on-demand database service environment. For example, while only one or two devices of each type are shown in FIGS. 12A and 12B, some implementations of an on-demand database service environment can include anywhere from one to several devices of each type. Also, the on-demand database service environment need not include each device shown in FIGS. 12A and 12B, or can include additional devices not shown in FIGS. 12A and 12B.

Additionally, it should be appreciated that one or more of the devices in the on-demand database service environment 1200 can be implemented on the same physical device or on different hardware. Some devices can be implemented using hardware or a combination of hardware and software. Thus, terms such as “data processing apparatus,” “machine,” “server” and “device” as used herein are not limited to a single hardware device, rather references to these terms can include any suitable combination of hardware and software configured to provide the described functionality.

The cloud 1204 is intended to refer to a data network or multiple data networks, often including the Internet. Client machines communicably connected with the cloud 1204 can communicate with other components of the on-demand database service environment 1200 to access services provided by the on-demand database service environment. For example, client machines can access the on-demand database service environment to retrieve, store, edit, or process information. In some implementations, the edge routers 1208 and 1212 route packets between the cloud 1204 and other components of the on-demand database service environment 1200. For example, the edge routers 1208 and 1212 can employ the Border Gateway Protocol (BGP). The BGP is the core routing protocol of the Internet. The edge routers 1208 and 1212 can maintain a table of IP networks or ‘prefixes’, which designate network reachability among autonomous systems on the Internet.

In some implementations, the firewall 1216 can protect the inner components of the on-demand database service environment 1200 from Internet traffic. The firewall 1216 can block, permit, or deny access to the inner components of the on-demand database service environment 1200 based upon a set of rules and other criteria. The firewall 1216 can act as one or more of a packet filter, an application gateway, a stateful filter, a proxy server, or any other type of firewall.

In some implementations, the core switches 1220 and 1224 are high-capacity switches that transfer packets within the on-demand database service environment 1200. The core switches 1220 and 1224 can be configured as network bridges that quickly route data between different components within the on-demand database service environment. In some implementations, the use of two or more core switches 1220 and 1224 can provide redundancy or reduced latency.

In some implementations, the pods 1240 and 1244 perform the core data processing and service functions provided by the on-demand database service environment. Each pod can include various types of hardware or software computing resources. An example of the pod architecture is discussed in greater detail with reference to FIG. 12B. In some implementations, communication between the pods 1240 and 1244 is conducted via the pod switches 1232 and 1236. The pod switches 1232 and 1236 can facilitate communication between the pods 1240 and 1244 and client machines communicably connected with the cloud 1204, for example via core switches 1220 and 1224. Also, the pod switches 1232 and 1236 may facilitate communication between the pods 1240 and 1244 and the database storage 1256. In some implementations, the load balancer 1228 can distribute workload between the pods 1240 and 1244. Balancing the on-demand service requests between the pods can assist in improving the use of resources, increasing throughput, reducing response times, or reducing overhead. The load balancer 1228 may include multilayer switches to analyze and forward traffic.

In some implementations, access to the database storage 1256 is guarded by a database firewall 1248. The database firewall 1248 can act as a computer application firewall operating at the database application layer of a protocol stack. The database firewall 1248 can protect the database storage 1256 from application attacks such as structure query language (SQL) injection, database rootkits, and unauthorized information disclosure. In some implementations, the database firewall 1248 includes a host using one or more forms of reverse proxy services to proxy traffic before passing it to a gateway router. The database firewall 1248 can inspect the contents of database traffic and block certain content or database requests. The database firewall 1248 can work on the SQL application level atop the TCP/IP stack, managing applications' connection to the database or SQL management interfaces as well as intercepting and enforcing packets traveling to or from a database network or application interface.

In some implementations, communication with the database storage 1256 is conducted via the database switch 1252. The multi-tenant database storage 1256 can include more than one hardware or software components for handling database queries. Accordingly, the database switch 1252 can direct database queries transmitted by other components of the on-demand database service environment (for example, the pods 1240 and 1244) to the correct components within the database storage 1256. In some implementations, the database storage 1256 is an on-demand database system shared by many different organizations as described above.

FIG. 12B shows a system diagram further illustrating example architectural components of an on-demand database service environment according to some implementations. The pod 1244 can be used to render services to a user of the on-demand database service environment 1200. In some implementations, each pod includes a variety of servers or other systems. The pod 1244 includes one or more content batch servers 1264, content search servers 1268, query servers 1282, file force servers 1286, access control system (ACS) servers 1280, batch servers 1284, and app servers 1288. The pod 1244 also can include database instances 1290, quick file systems (QFS) 1292, and indexers 1294. In some implementations, some or all communication between the servers in the pod 1244 can be transmitted via the switch 1236.

In some implementations, the app servers 1288 include a hardware or software framework dedicated to the execution of procedures (for example, programs, routines, scripts) for supporting the construction of applications provided by the on-demand database service environment 1200 via the pod 1244. In some implementations, the hardware or software framework of an app server 1288 is configured to execute operations of the services described herein, including performance of the blocks of various methods or processes described herein. In some alternative implementations, two or more app servers 1288 can be included and cooperate to perform such methods, or one or more other servers described herein can be configured to perform the disclosed methods.

The content batch servers 1264 can handle requests internal to the pod. Some such requests can be long-running or not tied to a particular customer. For example, the content batch servers 1264 can handle requests related to log mining, cleanup work, and maintenance tasks. The content search servers 1268 can provide query and indexer functions. For example, the functions provided by the content search servers 1268 can allow users to search through content stored in the on-demand database service environment. The file force servers 1286 can manage requests for information stored in the File force storage 1298. The File force storage 1298 can store information such as documents, images, and basic large objects (BLOBs). By managing requests for information using the file force servers 1286, the image footprint on the database can be reduced. The query servers 1282 can be used to retrieve information from one or more file storage systems. For example, the query system 1282 can receive requests for information from the app servers 1288 and transmit information queries to the NFS 1296 located outside the pod.

The pod 1244 can share a database instance 1290 configured as a multi-tenant environment in which different organizations share access to the same database. Additionally, services rendered by the pod 1244 may call upon various hardware or software resources. In some implementations, the ACS servers 1280 control access to data, hardware resources, or software resources. In some implementations, the batch servers 1284 process batch jobs, which are used to run tasks at specified times. For example, the batch servers 1284 can transmit instructions to other servers, such as the app servers 1288, to trigger the batch jobs.

In some implementations, the QFS 1292 is an open source file storage system available from Sun Microsystems® of Santa Clara, Calif. The QFS can serve as a rapid-access file storage system for storing and accessing information available within the pod 1244. The QFS 1292 can support some volume management capabilities, allowing many disks to be grouped together into a file storage system. File storage system metadata can be kept on a separate set of disks, which can be useful for streaming applications where long disk seeks cannot be tolerated. Thus, the QFS system can communicate with one or more content search servers 1268 or indexers 1294 to identify, retrieve, move, or update data stored in the network file storage systems 1296 or other storage systems.

In some implementations, one or more query servers 1282 communicate with the NFS 1296 to retrieve or update information stored outside of the pod 1244. The NFS 1296 can allow servers located in the pod 1244 to access information to access files over a network in a manner similar to how local storage is accessed. In some implementations, queries from the query servers 1282 are transmitted to the NFS 1296 via the load balancer 1228, which can distribute resource requests over various resources available in the on-demand database service environment. The NFS 1296 also can communicate with the QFS 1292 to update the information stored on the NFS 1296 or to provide information to the QFS 1292 for use by servers located within the pod 1244.

In some implementations, the pod includes one or more database instances 1290. The database instance 1290 can transmit information to the QFS 1292. When information is transmitted to the QFS, it can be available for use by servers within the pod 1244 without using an additional database call. In some implementations, database information is transmitted to the indexer 1294. Indexer 1294 can provide an index of information available in the database 1290 or QFS 1292. The index information can be provided to file force servers 1286 or the QFS 1292.

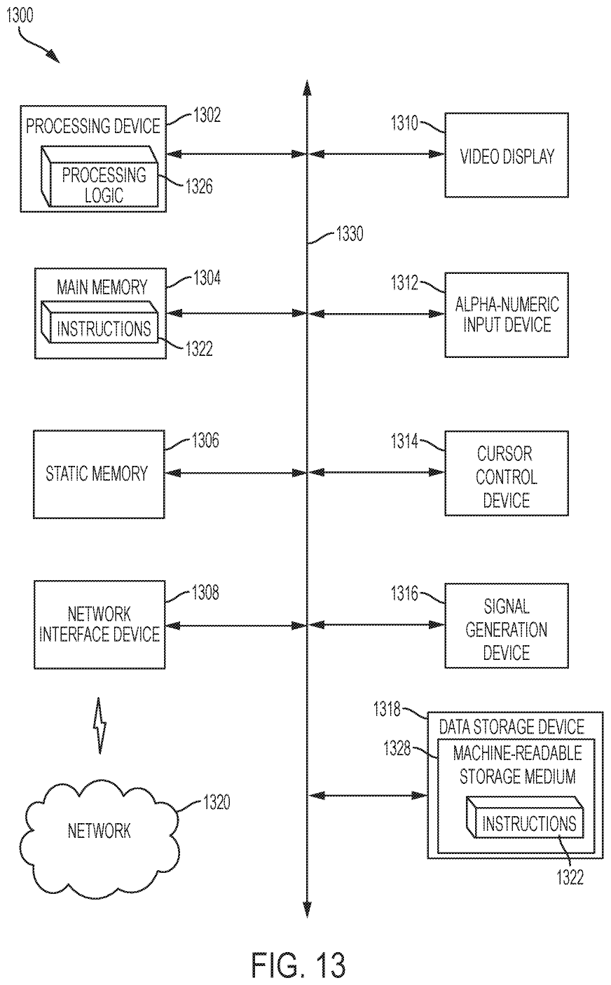

FIG. 13 illustrates a diagrammatic representation of a machine in the exemplary form of a computer system 1300 within which a set of instructions, for causing the machine to perform any one or more of the methodologies discussed herein, may be executed. The system 1300 may be in the form of a computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 1300 may represent application server 110.

The exemplary computer system 1300 includes a processing device (processor) 1302, a main memory 1304 (e.g., read-only memory (ROM), flash memory, dynamic random access memory (DRAM) such as synchronous DRAM (SDRAM)), a static memory 1306 (e.g., flash memory, static random access memory (SRAM)), and a data storage device 1318, which communicate with each other via a bus 1330.

Processing device 1302 represents one or more general-purpose processing devices such as a microprocessor, central processing unit, or the like. More particularly, the processing device 1302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1302 may also be one or more special-purpose processing devices such as an application specific integrated circuit (ASIC), a field programmable gate array (FPGA), a digital signal processor (DSP), network processor, or the like.

The computer system 1300 may further include a network interface device 1308. The computer system 1300 also may include a video display unit 1310 (e.g., a liquid crystal display (LCD) or a cathode ray tube (CRT)), an alphanumeric input device 1312 (e.g., a keyboard), a cursor control device 1314 (e.g., a mouse), and a signal generation device 1316 (e.g., a speaker).

The data storage device 1318 may include a computer-readable medium 1328 on which is stored one or more sets of instructions 1322 (e.g., instructions of in-memory buffer service 114) embodying any one or more of the methodologies or functions described herein. The instructions 1322 may also reside, completely or at least partially, within the main memory 1304 and/or within processing logic 1326 of the processing device 1302 during execution thereof by the computer system 1300, the main memory 1304 and the processing device 1302 also constituting computer-readable media. The instructions may further be transmitted or received over a network 1320 via the network interface device 1308.

While the computer-readable storage medium 1328 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

Particular embodiments may be implemented in a computer-readable storage medium (also referred to as a machine-readable storage medium) for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

A “processor,” “processor system,” or “processing system” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

The preceding description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

In the above description, numerous details are set forth. It will be apparent, however, to one of ordinary skill in the art having the benefit of this disclosure, that embodiments of the invention may be practiced without these specific details. In some instances, well-known structures and devices are shown in block diagram form, rather than in detail, in order to avoid obscuring the description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “analyzing,” “identifying,” “adding,” “displaying,” “generating,” “querying,” “creating,” “selecting” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method, comprising:
storing a pool of digital crypto tokens for an organization and a distributed ledger in a blockchain that comprises a network of blockchain nodes, wherein the digital crypto tokens comprise: granted digital crypto tokens and transferable digital crypto tokens;
controlling distribution of the digital crypto tokens to users associated with the organization, wherein controlling comprises:
validating each transaction involving the digital crypto tokens, at a smart contract module prior to issuing digital crypto tokens to users of the organization, using a smart contract for each transaction to directly control peer-to-peer transfer of the transferable digital crypto tokens between the user and another user; and
issuing, at a reward system integrated with a cloud computing platform, the granted digital crypto tokens to at least one user as a reward when the user performs certain tasks, wherein each granted digital crypto token quantifies time spent performing a certain task and serves as a currency within the organization.

2. The method according to claim 1, wherein the reward system further comprises:
generating, at a UI generator module when executed by a hardware-based processing system, at least one user interface at a computer of at least one user, wherein the user interface comprises:
a token summary UI element configurable to display a current balance of digital crypto tokens possessed by a particular user, and a number of the transferrable digital crypto tokens that are currently transferrable by the particular user to other users;
a timeline UI element configurable to display an activity timeline that indicates recent token transactions that relate to the particular user;
a token trend UI element configurable to display a graph that illustrates a summary of a running total number of the digital crypto tokens possessed by the particular user at various points during a time period;
a recommendation UI element configurable to display a list of other users that the reward system recommends for potentially transferring the transferrable digital crypto tokens to;
a team UI element configurable to display a list of team members with a summary of a total number of the digital crypto tokens possessed by each team member; and
a leader UI element configurable to display a leader board for the organization where top users having the most digital crypto tokens are displayed along with a ranking and a total number of digital crypto tokens possessed by each of the top users listed in the leader board.

3. The method according to claim 1, wherein the users are employees of the organization, and wherein the reward system is a peer-to-peer employee reward system.

4. The method according to claim 1, wherein the digital crypto tokens are Ethereum tokens.

5. The method according to claim 1, wherein the digital crypto tokens are redeemable for one or more of:
money;
gifts; and
privileges.

6. The method according to claim 1, wherein the digital crypto tokens are redeemable for one or more of:
sponsorship of a charitable contribution;
sponsorship of a team event; and
sponsorship for conferences and educational training sessions.

7. The method according to claim 1, wherein the digital crypto tokens are redeemable for one or more of:
awards within the organization;
recognition within the organization;
meetings with others within the organization; and
assistance from others within the organization.

8. A system, comprising:
a cloud computing platform comprising a server system and a database system; and
a distributed database system configurable to store a pool of digital crypto tokens for an organization and a distributed ledger in a blockchain that comprises a network of blockchain nodes, wherein the network of blockchain nodes collectively store the distributed ledger, wherein the distributed ledger is configured to track and control distribution of the digital crypto tokens to users associated with the organization, wherein the digital crypto tokens comprise: granted digital crypto tokens and transferrable digital crypto tokens, wherein the distributed database system comprises:
a smart contract module, that when executed by a hardware-based processing system, is configurable to cause: validation of each transaction involving the digital crypto tokens, prior to issuing digital crypto tokens to users of the organization, using a smart contract for each transaction to directly control peer-to-peer transfer of the transferrable digital crypto tokens between the user and another user; and
a reward system integrated with the cloud computing platform and with the distributed database system, wherein the reward system comprises: a reward module, that when executed by a hardware-based processing system, is configurable to cause: the granted digital crypto tokens to be issued to at least one user as a reward when the user performs certain tasks, wherein each of the granted digital crypto token quantifies time spent performing a certain task and serves as a currency within the organization.

9. The system according to claim 8, wherein the reward system further comprises:
a UI generator module, that when executed by a hardware-based processing system, is configurable to cause: generation of at least one user interface at a computer of at least one user, wherein the user interface comprises:
a token summary UI element configurable to display a current balance of digital crypto tokens possessed by a particular user, and a number of the transferrable digital crypto tokens that are currently transferrable by the particular user to other users;
a timeline UI element configurable to display an activity timeline that indicates recent token transactions that relate to the particular user;
a token trend UI element configurable to display a graph that illustrates a summary of a running total number of the digital crypto tokens possessed by the particular user at various points during a time period;
a recommendation UI element configurable to display a list of other users that the reward system recommends for potentially transferring digital crypto tokens to;
a team UI element configurable to display a list of team members with a summary of a total number of the digital crypto tokens possessed by each team member; and
a leader UI element configurable to display a leader board for the organization where top users having the most digital crypto tokens are displayed along with a ranking and a total number of digital crypto tokens possessed by each of the top users listed in the leader board.

10. The system according to claim 8, wherein the users are employees of the organization, and wherein the reward system is a peer-to-peer employee reward system.

11. The system according to claim 8, wherein the digital crypto tokens are Ethereum tokens.

12. The system according to claim 8, wherein the digital crypto tokens are exchangeable for one or more of:
money;
gifts; and
privileges.

13. The system according to claim 8, wherein the digital crypto tokens are exchangeable for one or more of:
sponsorship of a charitable contribution;
sponsorship of a team event; and
sponsorship for conferences and educational training sessions.

14. The system according to claim 8, wherein the digital crypto tokens are exchangeable for one or more of:
awards within the organization;
recognition within the organization;
meetings with others within the organization; and
assistance from others within the organization.

15. A system comprising at least one hardware-based processor and memory, wherein the memory comprises processor-executable instructions encoded on a non-transient processor-readable media, wherein the processor-executable instructions, when executed by the processor, are configurable to cause:
storing, at a distributed database system, a pool of digital crypto tokens for an organization and a distributed ledger in a blockchain that comprises a network of blockchain nodes, wherein the digital crypto tokens comprise: granted digital crypto tokens and transferable digital crypto tokens;
controlling distribution of the digital crypto tokens to users associated with the organization, wherein controlling comprises:
validating each transaction involving the digital crypto tokens, at a smart contract module prior to issuing digital crypto tokens to users of the organization, using a smart contract for each transaction to directly control peer-to-peer transfer of the transferrable digital crypto tokens between the user and another user; and
issuing, at a reward system integrated with a cloud computing platform and with the distributed database system, the granted digital crypto tokens to at least one user as a reward when the user performs certain tasks, wherein each of the granted digital crypto token quantifies time spent performing a certain task and serves as a currency within the organization.

16. The system according to claim 15, wherein the processor-executable instructions, when executed by the processor, are further configurable to cause:
generating, at a UI generator module when executed by a hardware-based processing system, at least one user interface at a computer of at least one user, wherein the user interface comprises:
a token summary UI element configurable to display a current balance of digital crypto tokens possessed by a particular user, and a number of the transferrable digital crypto tokens that are currently transferrable by the particular user to other users;
a timeline UI element configurable to display an activity timeline that indicates recent token transactions that relate to the particular user;
a token trend UI element configurable to display a graph that illustrates a summary of a running total number of the digital crypto tokens possessed by the particular user at various points during a time period;
a recommendation UI element configurable to display a list of other users that the reward system recommends for potentially transferring digital crypto tokens to;
a team UI element configurable to display a list of team members with a summary of a total number of the digital crypto tokens possessed by each team member; and
a leader UI element configurable to display a leader board for the organization where top users having the most digital crypto tokens are displayed along with a ranking and a total number of digital crypto tokens possessed by each of the top users listed in the leader board.

17. The system according to claim 15, wherein the users are employees of the organization, and wherein the reward system is a peer-to-peer employee reward system.

18. The system according to claim 15, wherein the digital crypto tokens are Ethereum tokens.

19. The system according to claim 15, wherein the digital crypto tokens are redeemable for one or more of:
money;
gifts; and
privileges.

20. The system according to claim 15, wherein the digital crypto tokens are redeemable for one or more of:
sponsorship of a charitable contribution;
sponsorship of a team event;
sponsorship for conferences and educational training sessions;
awards within the organization;
recognition within the organization;
meetings with others within the organization; and
assistance from others within the organization.
